(19) United States
(12) Patent Application Publication
(10) Pub. No.: US 2011/0056449 A1
(43) Pub. Date: Mar. 10, 2011

(54) IGNITION COIL FOR VEHICLE

(75) Inventors: Harry Oliver Levers, JR., El Paso, TX (US); Albert Anthony Skinner, El Paso, TX (US); Colin Hamer, El Paso, TX (US)

(73) Assignee: DELPHI TECHNOLOGIES, INC., Troy, MI (US)

(21) Appl. No.: 12/555,397

(22) Filed: Sep. 8, 2009

(51) Int. Cl. H01T 13/08; H01F 27/28; H01F 38/12

(52) U.S. Cl. 123/169 R; 336/182

(57) ABSTRACT

A secondary winding spool for an ignition coil has two segments, one residing within a spark plug well and the other having a larger diameter than the well and residing above the well, to maximize exploitation of coil space in an engine.

### FIELD OF THE INVENTION

The present invention relates generally to vehicle ignition coils.

### BACKGROUND OF THE INVENTION

Ignition coils are components that use the coupling between a primary winding and a secondary winding to transform relatively low voltages from the battery into high voltages that are supplied to the spark plugs in vehicle gasoline engines. The spark plugs start the internal combustion process that drives the rods and hence, crankshaft and axles. In older systems, a single ignition coil is provided, and a distributor sends the pulses from the coil through respective high voltage spark plug wires to the spark plugs in the cylinders in accordance with a timing that is established by the distributor.

In relatively modern engines, an engine can have several ignition coils, one for each cylinder or for each pair of cylinders, thereby advantageously eliminating the need for distributors and high voltage wires and also providing more precise control of the engine timing. One example of such an ignition coil system is set forth in U.S. Pat. No. 6,556,118, owned by the present assignee and incorporated herein by reference.

Ignition coils have been made in a cylindrical configuration with a small diameter (generally 22-27 mm) that is meant to fit into a spark plug well. These are commonly referred to as pencil coils. A pencil coil is relatively long. In applications with limited spark plug well height, a coil that resides above the spark plug well (known as a plug top coil or “PTC”) may be used. A PTC is shorter than a pencil coil and exploits room above the well, where the diameter of the space into which the coil must reside is less restricted than that of a spark plug well.

### SUMMARY OF THE INVENTION

As understood herein, a disadvantage of a plug top coil is that the space within the well that would otherwise be occupied by a pencil coil remains unused. Another disadvantage of a PTC as recognized herein is that the silicone boot that is used to insulate the output of the coil from the well must be made longer than it would be for a pencil coil and, thus, and relatively more expensive.

Accordingly, an ignition coil assembly for an engine spark plug includes an axially lower secondary winding spool segment defining a first radius and an axially upper secondary winding spool segment defining a second radius larger than the first radius, with the segments being axially contiguous to each other. A secondary winding is on the segments and a primary winding core extends within the segments and bears a primary winding.

In an example embodiment the axially lower segment is disposable in a spark plug well and the axially upper segment is disposable above the well. The first radius is thus smaller than the radius of the well and the second radius can be larger than the radius of the well. If desired, the axially lower segment is longer than the axially upper segment, and the secondary winding can be progressively wound on the axially lower segment and wound in a segmented configuration on the axially upper segment.

The primary winding core may include an axially lower core segment disposed within the axially lower secondary winding spool segment and an axially upper core segment disposed within the axially upper secondary winding spool segment. The number of primary winding layers on the axially lower core segment can be different than the number of primary winding layers on the axially upper core segment. For example, the axially upper core segment can bear more primary winding layers than the axially lower core segment.

In another aspect, a method for providing voltage to an engine spark plug in a spark plug well includes disposing within the well an axially lower secondary winding spool segment defining a diameter less than the diameter of the well. A portion of a secondary coil winding is wound on the lower secondary winding spool segment. The method also includes disposing above the well an axially upper secondary winding spool segment defining a diameter greater than the diameter of the well. A portion of the secondary coil winding is wound on the upper secondary winding spool segment. Electrical communication between the spark plug and the secondary winding is established.

In another aspect, a method includes providing an ignition coil assembly, and mounting the ignition coil assembly within a spark well with a portion of the assembly disposed above the well in electrical communication with a spark plug in the well.

In another aspect, an apparatus includes an axially lower secondary winding spool segment defining a first radius, an axially upper secondary winding spool segment defining a second radius different from the first radius, and a secondary winding on both segments. A primary winding core extends within the segments and bears a primary winding. A different number of layers of the primary winding are on the core adjacent the lower secondary winding spool segment then are on the core adjacent the upper secondary winding spool segment.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic view of a gasoline-powered engine with a spark plug and ignition coil; and

FIG. 2 is a side plan view of an example embodiment with an axially lower secondary winding spool segment defining a first radius and an axially upper secondary winding spool segment defining a second larger radius.

### DETAILED DESCRIPTION OF THE PREFERRED EMBODIMENT

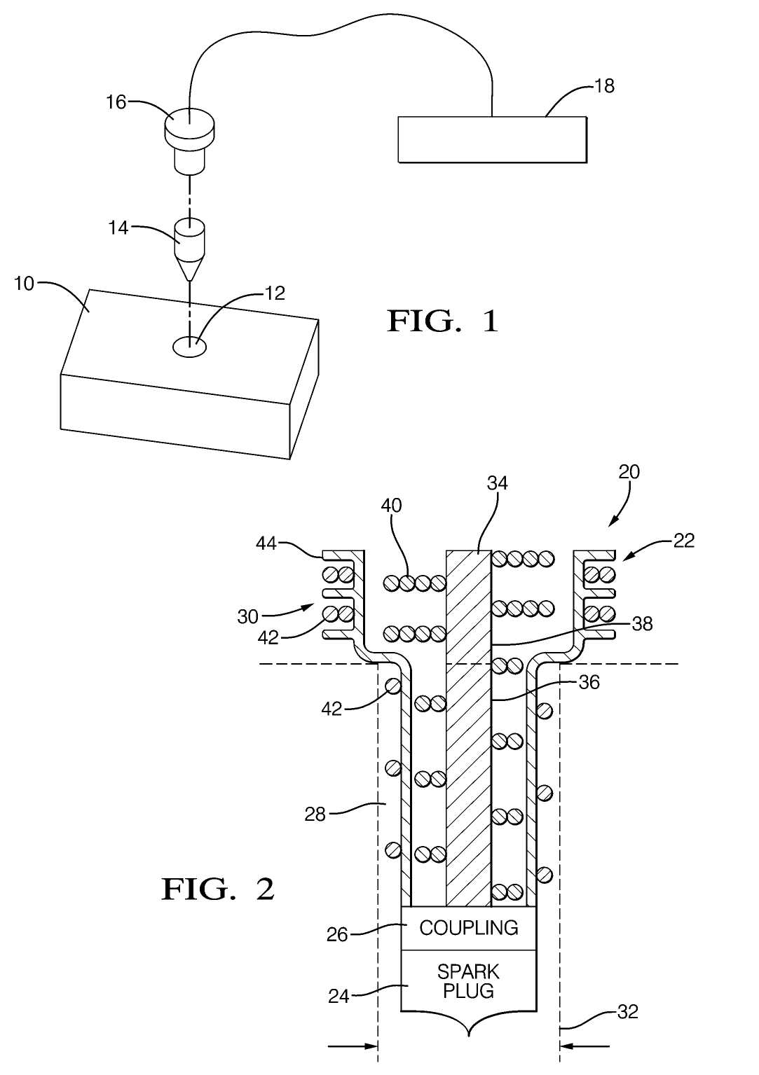

Beginning initially with FIG. 1, a gasoline-powered engine is shown. The engine 10 may have at least one spark plug well 12 which, in non-limiting embodiments, may be in either the engine block or an engine head. The well 12 is capable of receiving a spark plug 14. Should the well 12 be made of a non-conductive material, a shield providing an outer magnetic return path is not required.

Typically, the plug 14 is electrically connected to a coil 16. It is to be understood that the coil 16 is capable of transforming relatively low voltages from a battery 18 into high voltages that are supplied to the plug 14 so that the plug 14 may create a spark. The plug 14 may thus initiate the internal combustion process of the engine 10. It is to be further understood that the coil 16 and the coil to be referenced in FIG. 2 may be waste spark (also known as a two-tower) ignition coil or a high energy coil per cylinder in non-limiting embodiments.

Proceeding to FIG. 2, an ignition coil assembly is shown, numbered 20, it being understood that coil assembly 20 shown in FIG. 2 can embody the coil 16 of FIG. 1. The ignition coil assembly 20 has an ignition coil 22. The coil 22 may supply voltage from a battery (not shown) to a spark plug 24 through a coupling 26, the coupling 26 potentially being a cup and spring coupling in non-limiting embodiments.

The coil 22 has an axially lower winding spool segment 28 defining a first radius and an axially upper winding spool segment 30 defining a second radius larger than the first radius, where both segments are axially contiguous to each other and bear a secondary winding discussed below. Both the lower segment 28 and upper segment 30 may be composed of a plastic in non-limiting embodiments.

Moreover, the lower segment 28 is configured for being disposed in a spark plug well 32 and the upper segment 30 is configured for being disposed above the well 32. It is to be understood that the lower segment 28 may be longer than the upper segment 30. It is to be further understood that the diameter of the well 32 is greater than the diameter of the lower segment 28 but less than the diameter of the upper segment 30.

Sill referencing FIG. 2, the ignition coil assembly 20 has a primary winding core 34 which extends within both the lower segment 28 and upper segment 30. Specifically, the core 34 may have an axially lower core segment 36 disposed within the axially lower secondary winding spool segment 28 and an axially upper core segment 38 disposed within the axially upper secondary winding spool segment 30. The core 34 bears a primary winding 40 wound around the core 34 in accordance with ignition coil principles known in the art. It is to be understood that the primary winding 40 is electrically connected to an ignition system that selectively energizes the primary winding 40 from a source of voltage such as a vehicle battery in accordance with ignition coil principles known in the art, which in turn is inductively coupled to the secondary windings such that the coil 22 provides needed voltage to the plug 24 to create a spark.

Furthermore, in non-limiting embodiments the number of primary winding layers on the axially lower core segment 36 may be different than the number of primary winding layers on the axially upper core segment 38. Thus, the axially upper core segment 38 may bear more primary winding layers than the axially lower core segment 36. For example, in the specific non-limiting embodiment shown in FIG. 2, the upper core segment 38 may bear four winding layers whereas the lower core segment 36 may bear two winding layers.

Still remaining with FIG. 2, the assembly 20 having the lower secondary winding spool segment 28 and upper secondary winding spool segment 30 has a secondary winding 42. In example non-limiting embodiments the secondary winding 42 may be progressively wound on the lower segment 28 and can be wound in a segmented configuration on the upper segment 30. To maintain a segmented winding configuration on the upper segment 30, disk-shaped ribs 44 are formed on the upper segment 30. Further, in non-limiting embodiments a pole piece or flux director may be used to improve coupling between then upper core segment 38 and upper secondary segment 30.

When the primary winding 40 is energized, the cooperation between the core 34, primary winding 40, and secondary winding 42 results in inductive coupling between the primary winding 40 and secondary winding 42. Owing to this coupling and to the different number of layers between primary and secondary, the relatively low battery voltage in the primary winding 42 is transformed into relatively higher voltages in the secondary winding 42 for provision of the higher voltages to the spark plugs.

While the particular IGNITION COIL FOR VEHICLE is herein shown and described in detail, it is to be understood that the subject matter which is encompassed by the present invention is limited only by the claims.

What is claimed is:

1. Ignition coil assembly for an engine spark plug, comprising:
an axially lower secondary winding spool segment defining a first radius;
an axially upper secondary winding spool segment defining a second radius larger than the first radius, the segments being axially contiguous to each other;
a secondary winding on the segments; and
a primary winding core extending within the segments and bearing a primary winding.

2. The assembly of claim 1, wherein the axially lower segment is disposable in a spark plug well and the axially upper segment is disposable above the well, the first radius being smaller than the radius of the well and the second radius being larger than the radius of the well.

3. The assembly of claim 2, wherein the axially lower segment is longer than the axially upper segment.

4. The assembly of claim 1, wherein the secondary winding is progressively wound on the axially lower segment and is wound in a segmented configuration on the axially upper segment.

5. The assembly of claim 1, wherein the primary winding core includes an axially lower core segment disposed within the axially lower secondary winding spool segment and an axially upper core segment disposed within the axially upper secondary winding spool segment, a number of primary winding layers on the axially lower core segment being different than a number of primary winding layers on the axially upper core segment.

6. The assembly of claim 5, wherein the axially upper core segment bears more primary winding layers than the axially lower core segment.

7. The assembly of claim 1, comprising a vehicle spark plug electrically connected to the secondary winding.

8. A method for providing voltage to an engine spark plug in a spark plug well, comprising:
disposing within the well an axially lower secondary winding spool segment defining a diameter less than the diameter of the well, a portion of a secondary coil winding being wound on the lower secondary winding spool segment;
disposing above the well an axially upper secondary winding spool segment defining a diameter greater than the diameter of the well, a portion of the secondary coil winding being wound on the upper secondary winding spool segment; and
establishing electrical communication between the spark plug and the secondary winding.

9. The method of claim 8, comprising disposing a primary winding core within the segments, the core bearing a primary winding.

10. The method of claim 8, wherein the axially lower segment is longer than the axially upper segment.

11. The method of claim 8, wherein the secondary winding is progressively wound on the axially lower segment and is wound in a segmented configuration on the axially upper segment.

12. The method of claim 9, wherein the primary winding core includes an axially lower core segment disposed within the axially lower secondary winding spool segment and an axially upper core segment disposed within the axially upper secondary winding spool segment, a number of primary winding layers on the axially lower core segment being different than a number of primary winding layers on the axially upper core segment.

13. The method of claim 12, wherein the axially upper core segment bears more primary winding layers than the axially lower core segment.

14. Method comprising:
providing an ignition coil assembly; and
mounting the ignition coil assembly within a spark well with a portion of the assembly disposed above the well in electrical communication with a spark plug in the well.

15. Apparatus comprising:
an axially lower secondary winding spool segment defining a first radius;
an axially upper secondary winding spool segment defining a second radius different from the first radius;
a secondary winding on both segments; and
a primary winding core extending within the segments and bearing a primary winding, a different number of layers of the primary winding being on the core adjacent the lower secondary winding spool segment then a number of layers of the primary winding on the core adjacent the upper secondary winding spool segment.

16. The assembly of claim 15, wherein the axially lower segment is disposable in a spark plug well and the axially upper segment is disposable above the well, the first radius being smaller than the radius of the well and the second radius being larger than the radius of the well.

17. The assembly of claim 15, wherein the axially lower segment is longer than the axially upper segment.

18. The assembly of claim 15, wherein the secondary winding is progressively wound on the axially lower segment and is wound in a segmented configuration on the axially upper segment.

19. The assembly of claim 15, wherein the primary winding core includes an axially lower core segment disposed within the axially lower secondary winding spool segment and an axially upper core segment disposed within the axially upper secondary winding spool segment, wherein the axially upper core segment bears more primary winding layers than the axially lower core segment.
